(19) United States
(12) Patent Application Publication
(10) Pub. No.: US 2026/0109556 A1
(43) Pub. Date: Apr. 23, 2026

(54) APPARATUS FOR TRANSPORTING OBJECTS

(71) Applicant: I.M.A. INDUSTRIA MACCHINE AUTOMATICHE S.P.A., OZZANO DELL'EMILIA (BO) (IT)

(72) Inventors: Claudio TREBBI, OZZANO DELL'EMILIA (BO) (IT); Mattia CHIANURA

(21) Appl. No.: 19/111,878

(22) PCT Filed: Sep. 6, 2023
(86) PCT No.: PCT/IT2023/050200

§ 371 Date: Mar. 14, 2025

(30) Foreign Application Priority Data
Sep. 19, 2022 (IT) IT102022000019107

(51) Int. Cl. B65G 54/02

(52) U.S. Cl. CPC B65G 54/02

(57) ABSTRACT

Transport apparatus (10) for transporting objects (11) which comprises a reference surface (13), at least one transport member (18) for supporting and transporting the objects (11) with respect to the reference surface (13), magnetic members (23) and energization electric members (15), configured to interact with the magnetic members (23) and consequently cause the selective displacement of the transport member (18), wherein at least one wireless power transmitter (28) selectively transmits energy to at least one wireless power receiver (30).

### FIELD OF THE INVENTION

The present invention concerns an apparatus for automatically transporting one or several objects, for example components for manufacturing a product or a package, to and from a plurality of processing stations.

The apparatus according to the present invention performs the function of transporting the aforementioned objects and requires electric energy to power an on-board electric device, for example to implement a mean for supporting or gripping the one or several objects, or to act as a sensor or detector, or to carry out other types of operations on the one or several objects, such as for example weighing, delivery or filling operations, or similar or comparable operations.

Moreover, the apparatus can be used, for example, in a machine for manufacturing packages of products, especially with a small mass, for example in the chemical, cosmetic and/or pharmaceutical sector, such as bottles, flasks, caps, ring nuts, or other objects of similar sizes.

### BACKGROUND OF THE INVENTION

In the industrial sector of packaging chemical, cosmetic and/or pharmaceutical products, various apparatuses and methods are known for automatically transporting one or more components in order to produce a package, in particular a package for a product with a small mass, such as bottles, flasks, caps, ring nuts, or other objects of similar sizes, to and from one or more processing stations, many of which are designed, manufactured and marketed by the Applicant.

In this sector, there is an ever-increasing demand for apparatuses that can move the components for producing the package from one processing station to another, in an environment that is safe and sterilized, ecologically sustainable and quiet, without generating pollutants and agents that may contaminate the product and/or its contents, and in which human intervention to carry out the usual operations of the sector (cleaning, format change, maintenance, biological test monitoring, or other) is reduced to a minimum, if not even eliminated.

Transport devices of the electromagnetic type, also called “planar motors”, are known, which comprise magnetic means, which cooperate with energization means associated therewith, configured to selectively generate one or more magnetic fields to influence the magnetic means.

In planar motors, the magnetic means are usually configured as coils included in a mobile transport member, and the energization electric means are incorporated within a fixed surface on which the transport member can move without contact thanks to the controlled electromagnetic field that is generated between the magnetic means and the energization electric means.

These planar motors are very versatile, since they allow to follow very different trajectories and paths, with both rectilinear segments as well as curved segments, with respect to a movement surface, appropriately commanding the electric energization means.

Furthermore, planar motors can be advantageously used on both horizontal and also inclined movement surfaces, or even on vertical movement surfaces.

The mobile transport members associated with such planar motors are usually provided with electrically driven devices, such as for example support or gripping means, used to stably support one or more components during their movement, or electric devices to carry out other operations. In general, therefore, these transport members require electric energy to power the on-board electric devices, for example in order to actuate the support means mentioned above. The supply of electric energy on board the mobile transport members in a reliable, safe and fast manner is therefore particularly important, especially in the context of non-contact transport by means of planar motors.

Also in the industrial sector of packaging food products, which is adjacent to that of packaging the products as above, from patent documents DE 102020114084 A1 and EP 3656707 A1 solutions are known that provide a drive of the non-contact electromagnetic type of some components. In particular, document DE 102020114084 A1 describes an electromagnetic drive for driving sucker handling members which are configured to pick up the products in transit on an underlying conveyor belt, while document EP 3656707 A1 describes transport members configured as the aforementioned “planar motors” and disposed to receive the packages of the products to be transported.

Although the food sector's processing environments necessarily require hygiene and cleaning standards, the regulations set forth for this processing environment are less stringent than those of the industrial sector of packaging chemical, cosmetic and/or pharmaceutical products, where it is necessary to have an environment that meets certain sterility requirements. This makes the apparatuses described by the patent documents mentioned above unsuitable to be used for packaging such products.

There is therefore the need to perfect a transport apparatus that can overcome at least one of the disadvantages of the state of the art.

The Applicant has devised, tested and embodied the present invention to overcome the shortcomings of the state of the art and to obtain these and other purposes and advantages.

### SUMMARY OF THE INVENTION

The present invention is set forth and characterized in the independent claim. The dependent claims describe other characteristics of the present invention or variants to the main inventive idea.

In accordance with the above purposes and to resolve the technical problem disclosed above in a new and original way, also achieving considerable advantages compared to the state of the prior art, a transport apparatus for automatically transporting objects according to the present invention comprises a support wall, which has at least one reference surface; at least one transport member configured to support and transport the one or several objects and to be able to move in at least two degrees of freedom, and without contact, with respect to the reference surface; and energization electric means configured to selectively generate one or several magnetic fields associated with the reference surface, wherein the at least one transport member comprises magnetic means configured to interact with the energization electric means and consequently cause the selective displacement of the at least one transport member; wherein, furthermore, at least one electric device, configured to operate by means of electric energy, is present on board the transport member.

In accordance with one aspect of the present invention, the apparatus comprises a fixed wireless power transmitter provided with a wireless power transmitter coil; a wireless power receiver associated with the transport member in order to move integrally therewith and provided with a wireless power receiver coil able to magnetically couple to the wireless power transmitter coil in order to receive electrical power. The wireless power receiver is connected to the electric device disposed on board the transport member in order to supply the electrical power received from the wireless power transmitter to the electric device, so as to enable the operation of the electric device.

Doing so achieves at least the advantage of being able to power with electric energy at least one electric device associated with the support member.

In accordance with another aspect of the present invention, the wireless power receiver is connected to an actuator which drives the electric device.

In accordance with another aspect of the present invention, the wireless power receiver is integrally mobile together with the transport member on the reference surface in order to selectively approach the fixed wireless power transmitter, so as to magnetically couple the wireless power receiver coil to the wireless power transmitter coil.

In accordance with another aspect of the present invention, the wireless power receiver is autonomous and independent with respect to the magnetic means, or the wireless power receiver is defined by at least one part of the electromagnetic circuit of the magnetic means.

In accordance with another aspect of the present invention, the wireless power receiver is attached projecting from the transport member.

In accordance with another aspect of the present invention, the wireless power receiver is installed integrated inside the transport member.

In accordance with another aspect of the present invention, the wireless power receiver is mounted externally to the transport member and is connected by means of a rigid support projecting from the transport member.

In accordance with another aspect of the present invention, the wireless power transmitter is installed integrated in the support wall.

In accordance with another aspect of the present invention, the wireless power transmitter is defined by at least one part of the electromagnetic circuit of the energization electric means.

In accordance with another aspect of the present invention, the wireless power transmitter is autonomous and independent with respect to the energization electric means.

In accordance with another aspect of the present invention, the wireless power transmitter is mounted externally to the support wall.

In accordance with another aspect of the present invention, the at least one transport member comprises an energy storage element configured to store the power coming from the wireless power receiver, and to deliver the stored power to the electric device, so that the wireless power receiver supplies the electrical power received from the wireless power transmitter to the electric device by means of the energy storage element.

In accordance with another aspect of the present invention, the electric device is chosen from a gripping device able to be driven between a gripping and a release position, a sensor device configured to detect a state, a weighing device configured to measure a weight, a filling device configured to deliver a liquid, or a combination thereof.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a three-dimensional and schematic view of an apparatus for transporting objects according to the present invention in accordance with a first embodiment;

FIG. 2 is a three-dimensional and schematic view of an enlarged detail of FIG. 1, in which the detail is shown from a different angle from that of FIG. 1;

FIG. 3 is a three-dimensional and schematic view of the detail of FIG. 2, according to a variant;

FIG. 4 is a three-dimensional and schematic view of an apparatus for transporting objects according to the present invention in accordance with a third embodiment;

FIGS. from 5 to 7 show schematic examples of possible models of distribution of the energization electric means with respect to a reference surface of an apparatus for transporting objects according to the present invention;

FIG. 8 is a schematic block diagram relating to the operation of the apparatus of FIG. 1;

FIGS. 9 and 10 are lateral and schematic views of the enlarged detail of FIG. 2, shown in two different operating conditions;

FIG. 11 is a lateral and schematic view of the enlarged detail of FIG. 2, in which a portion of the reference surface comprised in the embodiments of the apparatus according to the present invention described here is also visible.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

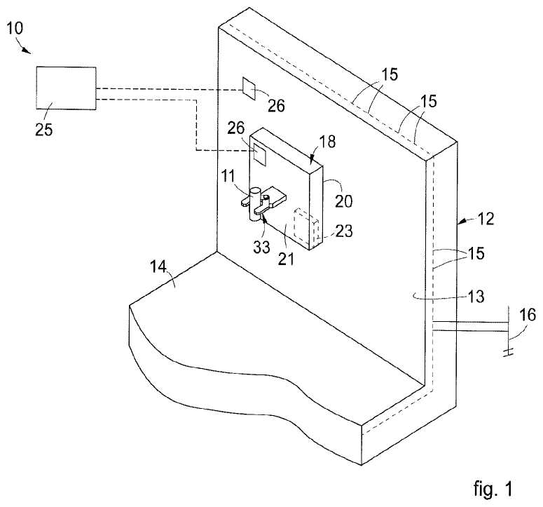

With reference to FIG. 1, an apparatus 10 according to the present invention is configured to automatically transport one or several objects 11 according to desired paths or directions, from a point of departure to a point of arrival.

The apparatus 10 can be used, for example, in a machine for packaging products of the chemical, cosmetic and/or pharmaceutical sectors, for transporting one or several objects 11, or components, to and from one or more processing stations.

The one or several objects 11 can comprise containers which can be used in the chemical, medical and pharmaceutical fields, for example bottles, flasks, or even dosing nozzles, configured to fill the containers as above.

The machine, which is not shown in the drawings, can be, for example, of the type described in the international patent application WO2021/001863A1 filed by the Applicant, and essentially comprises a plurality of processing stations, disposed in a direction of advance which has rectilinear and/or curved segments.

The apparatus 10 comprises a support wall 12 having a reference surface 13 which can be either vertical or horizontal (FIG. 4). Alternatively, the reference surface 13 can have any development whatsoever, and comprise vertical, horizontal, curved and/or inclined parts.

A base wall 14 (FIG. 1) is provided, which can be any substantially horizontal wall, either of the apparatus 10 or of the machine in which the latter is installed, or the floor on which the machine itself rests.

With the reference surface 13 there are associated energization electric means 15 (FIGS. 1 and 4), of a known type and not shown in detail, which are configured to selectively generate one or more magnetic fields, even locally distributed, in certain zones of the same reference surface 13.

For example, the energization electric means 15 comprise a plurality of electric coils or windings, not shown in the drawings, suitably disposed, for example in the support wall 12, connected during use to an electric energy supply network 16 (FIG. 1) having suitable electric voltage and current values.

Moreover, the support wall 12 can be made with a plurality of modules, each comprising its own energization electric means 15, disposed adjacent to each other. In the latter case, the reference surface 13 is defined, as a whole, by the surfaces of the individual modules.

With the reference surface 13 there is associated a plurality of transport members 18, of which only one is schematically shown in FIGS. 1 and 4, each of which can be moved with respect to the reference surface 13 thanks to the magnetic fields generated by the energization electric means 15.

For example, each transport member 18 can comprise a polygonal, regular or irregular, in particular quadrangular, for example square or rectangular, base or plan, or one that has other polygonal shapes defined by a closed broken line or by a combination of rectilinear and curved lines.

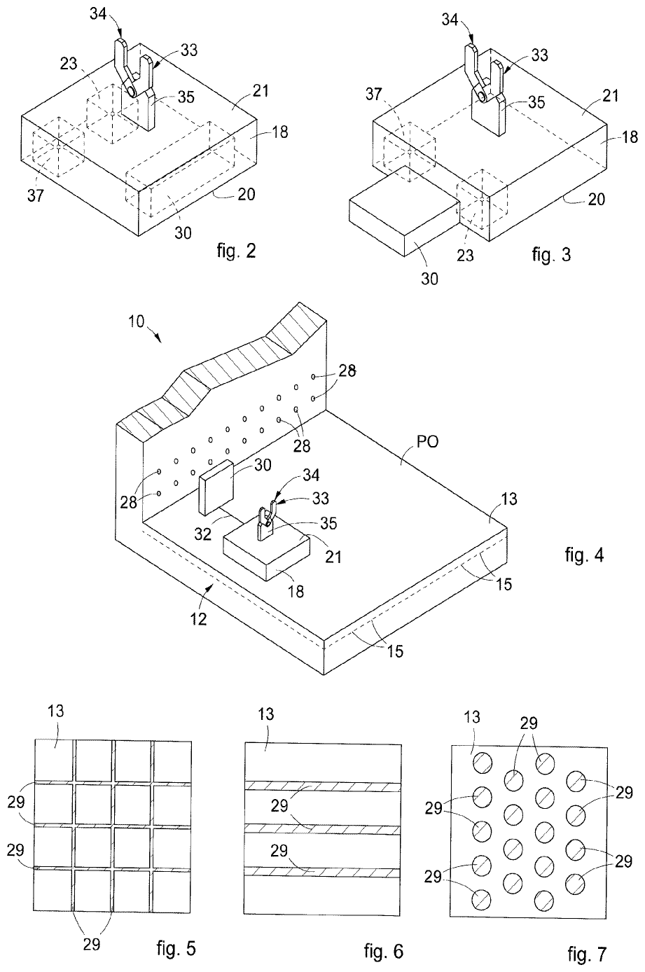

Each transport member 18 comprises a front surface 20 (FIGS. 2, 3, and 9-11), facing the reference surface 13 during use (FIG. 11), and a rear surface 21, opposite and parallel to the front surface 20.

According to possible embodiments, each transport member 18 can be provided with magnetic means 23 (FIGS. 1, 2 and 3), such as permanent magnets for example, of a known type and not shown in detail in the drawings.

The magnetic means 23 are configured to interact with one or more of the magnetic fields generated by the energization electric means 15, in such a way that each transport member 18 can move independently with respect to the reference surface 13 remaining slightly distanced with respect to it, that is, without contact.

For example, during each displacement, the transport member 18 can be operatively maintained at a certain first distance D1 (FIG. 11), comprised between about 0.2 mm and about 4.5 mm, with respect to the reference surface 13. By the expression “first distance DI” in the present description we mean a distance, constant or variable, such as to allow a correct interaction between the energization electric means 15 and the magnetic means 23, and therefore comprised in the range of reference values mentioned above.

The transport members 18 are preferably made as the mobile parts of magnetically driven “planar motors”, per se known in the state of the art.

Each transport member 18 (FIG. 1) is configured to be moved and/or rotated with respect to the reference surface 13, as well as independently and without contact, also without any constraint in path or direction, advantageously with at least two degrees of freedom.

The apparatus 10 also comprises control means, for example consisting of, or comprising, a control unit 25 (FIG. 1) configured to control the selective energization of the energization electric means 15 in relation to the path, or trajectory, that each transport member 18 follows during its movement.

The control unit 25 can comprise, for example, one or more processors, of a type known per se and programmable.

In particular, the control unit 25 is able to control, selectively and in a programmed manner, the electric current and/or voltage values to be supplied to the energization electric means 15, so that the latter can generate magnetic fields suitable to cause both the support of each transport member 18 in a certain position of the reference surface 13, and also the selective movement of each transport member 18 along such reference surface 13 according to a predefined path.

According to some embodiments, the apparatus 10 also comprises position sensors 26 associated with at least one of either the reference surface 13 or the at least one transport member 18, which are suitable to detect one or more of either the position, the speed of advance or possibly other parameters or states correlated to the movement of each transport member 18, and transmit the corresponding data to the control unit 25. In the embodiment of FIG. 1, the position sensors 26 are associated with both the reference surface 13 and also the transport member 18.

In this way, the control unit 25 can carry out a feedback control of the energization electric means 15 in order to move each transport member 18 according to a respective path.

For example, according to possible embodiments, the position sensors 26 can comprise a plurality of Hall effect sensors integrated in the support wall 12, which are coplanar or disposed in a parallel manner with respect to the energization electric means 15.

According to possible embodiments, the apparatus 10 comprises at least one fixed wireless power transmitter 28 (FIGS. 4, 8 and 11), provided with at least one wireless power transmitter coil 29 and configured to selectively transmit power and energy, for example electrical, to at least one wireless power receiver 30 associated with the transport member 18.

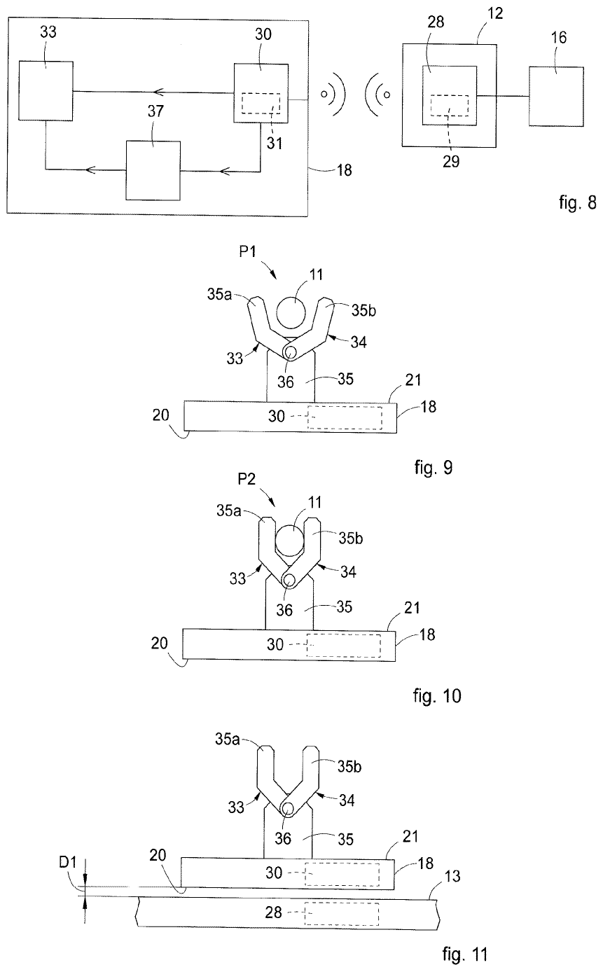

According to some embodiments, the at least one wireless power receiver 30 is associated with the transport member 18 in order to move integrally therewith, and it comprises at least one wireless power receiver coil 31 (schematized in FIG. 8).

The wireless power receiver 30 is integrally mobile together with the transport member 18 on the reference surface 13 in order to selectively approach the fixed wireless power transmitter 28, so as to magnetically couple the wireless power receiver coil 31 to the wireless power transmitter coil 29. According to some embodiments, the wireless power transmitter 28 can be installed integrated with the support wall 12 and be installed in such a way as to create a magnetic field, variable and controllable, in correspondence with the reference surface 13.

Moreover, the support wall 12 can contain inside it a plurality of wireless power transmitter coils 29 disposed according to a predefined pattern, for example checkerboard (FIG. 5), in strips (FIG. 6) or dotted (FIG. 7).

The wireless power transmitter 28 is connected to the power supply network 16 (FIG. 8) and is configured to generate a magnetic field, for example associated with the reference surface 13.

According to some embodiments, the wireless power transmitter 28 is defined by at least one part of the electromagnetic circuit of the energization electric means 15, or, according to other embodiments, the wireless power transmitter 28 is autonomous and independent with respect to the energization electric means 15.

The wireless power transmitter 28 and the wireless power receiver 30 are configured as a wireless charging system.

Referring to FIG. 2, the wireless power receiver 30 is installed integrated within the transport member 18.

Furthermore, according to a variant, the wireless power receiver 30 is mounted externally and directly projecting from the transport member 18 (FIG. 3).

According to some embodiments, the wireless power receiver 30 is autonomous and independent with respect to the magnetic means 23, or the wireless power receiver 30 can be defined by at least one part of the electromagnetic circuit of the same magnetic means 23.

Moreover, according to another embodiment shown in FIG. 4, the wireless power receiver 30 can be mounted externally to the transport member 18 and be connected thereto by means of a rigid support 32, for example a cable or a rod, directly protruding from the same transport member 18.

The wireless power transmitter 28 can be mounted externally to the support wall 12, for example associated with a portion of the base wall 14.

This advantageously allows to improve the interaction between the same wireless power receiver coil 31 and each wireless power transmitter coil 29.

Each transport member 18 can be provided with at least one electric device 33 (FIGS. 1, 2-4 and 9-11), for example installed in correspondence with the rear surface 21.

According to some embodiments, the wireless power receiver 30 supplies power directly to the electric device 33.

In other embodiments, the wireless power receiver 30 can power an actuator, for example a small sized electric motor or a battery, connected to the electric device 33.

In another embodiment, the wireless power receiver 30 can power a battery connected to an actuator connected to the electric device 33.

For example, the at least one electric device 33 can be chosen from a gripping device 34, a sensor device, detection means, a weighing device, a filling device configured to deliver a liquid, or a combination thereof.

According to possible embodiments, these electric devices can comprise gripping devices suitable to each grip a single object 11 or a tray or a container, on which a plurality of objects 11 can be positioned.

For example, the gripping devices 34 can comprise an electrically driven actuator, configured to be selectively activated and then moved between a first release operating position P1 (FIG. 9) and at least a second gripping operating position P2 (FIG. 10).

In particular, in the event the electric device 33 is configured as a gripping device 34, it can comprise a gripper 35, for example having a pair of jaws, 35a and 35b respectively, (FIGS. 9, 10 and 11) which are configured to rotate around a pin 36 and are connected to the electrically driven actuator (which is not shown in the attached drawings) which causes them to reciprocally move toward or way from each other, in a controlled manner, in order to alternately take the jaws 35a, 35b in the first release operating position P1 and in the second gripping operating position P2.

Furthermore, according to some embodiments, the control unit 25 is configured to control the selective command of the electric device 33.

Each transport member 18 comprises an energy storage element 37 (FIGS. 2, 3, and 8) configured to store the power received from the wireless power receiver 30.

The presence of the energy storage element 37 advantageously allows to activate the selective operation of the electric device 33, even when the wireless power receiver coil 31 of the transport member 18 does not directly interact with the magnetic field generated by the wireless power transmitter coil 29. For example, when the transport member 18 is located in a portion of the reference surface 13 not affected by the magnetic field generated by the wireless power transmitter coil 29.

Moreover, according to possible embodiments, the electric device 33 can be directly powered by the wireless power receiver 30 (FIG. 8), for example, when the energy storage element 37 is discharged, or when it is fully charged and the wireless power receiver 30 interacts with the wireless power transmitter 28.

It is clear that modifications and/or additions of parts may be made to the transport apparatus 10 as described heretofore, without departing from the field and scope of the present invention, as defined by the claims.

It is also clear that, although the present invention has been described with reference to some specific examples, a person of skill in the art will be able to achieve other equivalent forms of transport apparatuses 10, having the characteristics as set forth in the claims and hence all coming within the field of protection defined thereby.

In the following claims, the sole purpose of the references in brackets is to facilitate their reading and they must not be considered as restrictive factors with regard to the field of protection defined by the same claims.

1. Transport apparatus for automatically transporting one or several objects, comprising a support wall that has at least one reference surface; at least one transport member configured to support and transport said one or several objects and to be able to move in at least two degrees of freedom without contact with respect to said reference surface; and energization electric means configured to selectively generate one or several magnetic fields associated with said reference surface, wherein said at least one transport member comprises magnetic means configured to interact with said energization electric means and consequently cause the selective displacement of said at least one transport member, and wherein at least one electric device, configured to operate by means of electric energy, is present on board said transport member, wherein it comprises:
a fixed wireless power transmitter provided with a wireless power transmitter coil;
a wireless power receiver associated with said transport member in order to move integrally therewith and provided with a wireless power receiver coil able to magnetically couple to said wireless power transmitter coil in order to receive electrical power;
said wireless power receiver being connected to said electric device disposed on board said transport member in order to supply the electrical power received from said wireless power transmitter, in such a way as to enable the operation of said electric device.

2. Transport apparatus as in claim 1, wherein said wireless power receiver is connected to an actuator which drives said electric device.

3. Transport apparatus as in claim 1, wherein said wireless power receiver is autonomous and independent with respect to said magnetic means, or said wireless power receiver is defined by at least one part of the electromagnetic circuit of said magnetic means.

4. Transport apparatus as in claim 1, wherein said wireless power receiver is attached projecting from said transport member.

5. Transport apparatus as in claim 1, wherein said wireless power receiver is installed integrated inside said transport member.

6. Transport apparatus as in claim 1, wherein said wireless power receiver is mounted externally to said transport member and is connected by means of a support projecting from said transport member.

7. Transport apparatus as in claim 1, wherein said wireless power transmitter is installed integrated in said support wall.

8. Transport apparatus as in claim 7, wherein said wireless power transmitter is defined by at least one part of the electromagnetic circuit of said energization electric means.

9. Transport apparatus as in claim 7, wherein said wireless power transmitter is autonomous and independent with respect to said energization electric means.

10. Transport apparatus as in claim 1, wherein said wireless power transmitter is mounted externally to said support wall.

11. Transport apparatus as in claim 1, wherein said at least one transport member also comprises an energy storage element configured to store the power coming from said wireless power receiver, and to deliver the stored power to said electric device, so that said wireless power receiver supplies the electrical power received from said wireless power transmitter to said electric device by means of said energy storage element.

12. Transport apparatus as in claim 1, wherein said electric device is chosen from a gripping device able to be driven between a gripping and a release position, a sensor device configured to detect a state, a weighing device configured to measure a weight, a filling device configured to deliver a liquid, or a combination thereof.
